(19) United States
(12) Patent Application Publication
(10) Pub. No.: US 2009/0148707 A1
(43) Pub. Date: Jun. 11, 2009

(54) Glazing laminates

(75) Inventor: Jerrel C. Anderson, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 11/953,594

(22) Filed: Dec. 10, 2007

(51) Int. Cl. B32B 27/36; C08G 63/02

(52) U.S. Cl. 428/423.1; 528/272

(57) ABSTRACT

A surface-treated polyester film having one surface primed with an acrylic based primer and the other surface primed with a poly(alkyl amine) based primer and a glazing laminate comprising the same.

The present invention relates to a glazing laminates with improved durability.

### BACKGROUND OF THE INVENTION

Laminated safety glass has been used in windows and windshields of buildings and automobiles since the late 1930's. The laminated safety glass typically consists of a sandwich of two glass sheets or panels bonded together by an interlayer formed of polymeric film(s) or sheet(s). One or both of the glass sheets may be replaced by optically clear rigid polymer sheets or hardcoated polymeric films.

A glass/plastic laminate often comprises a hardcoated polyester film bonded to a glass sheet by a polymeric interlayer, such as those commercially available from E. I. du Pont de Nemours and Company, Wilmington, Del. (DuPont) under the trade name Spallshield® composite, where a hardcoated polyester film is bonded to a glass sheet by a poly(vinyl butyral) interlayer sheet.

In order to maintain the integrity and durability of the glass/plastic laminates and to prevent de-lamination during end-use, it is preferred that the polyester films are surface-treated to provide adequate adhesion to the polymeric interlayer and to the hardcoat. Certain energy treatments (e.g., controlled flame treatments or plasma treatments) have been used in the past with limited success. U.S. Pat. No. 5,415,942 discloses a polyester film primed with an acrylic based primer. When such a film is used in a glass/plastic laminate, the adhesion between the primed polyester film and the hardcoat may be improved but the adhesion between the polyester film and the polymeric interlayer is still not adequate. On the other hand, U.S. Pat. No. 7,189,457 discloses a polyester film primed with a poly(allyl amine) based primer. When such a film is used in a glass/plastic laminate, the adhesion between the polyester film and the polymeric interlayer is greatly improved but the adhesion between the polyester film and the hardcoat remains about the same as with the flame or plasma treatment.

Thus, there is still a need to provide a surface-treated polyester film which adheres directly to a hardcoat on one side and a polymeric interlayer on the other side with superior strength.

### SUMMARY OF THE INVENTION

The invention is directed to a surface-treated polyester film comprising a first surface primed with an acrylic based primer and a second surface primed with a poly(alkyl amine) based primer and a laminated glazing product comprising the same.

### DETAILED DESCRIPTION OF THE INVENTION

All references disclosed herein are incorporated by reference.

The invention provides a surface-treated polyester film having a first surface that is primed with an acrylic based primer and a second surface that is primed with a poly(alkyl amine) based primer. The surface-treated polyester film may have its first surface further coated with an abrasion resistant hardcoat over the acrylic based primer layer to form a hardcoated and surface-treated polyester film. The invention further provides a glazing laminate comprising a hardcoated and surface-treated polyester film and a polymeric interlayer, wherein the polymeric interlayer adheres directly to the poly(alkyl amine) primed surface of the polyester film. Such a laminate may further comprise a glass sheet adhering directly to the polymeric interlayer at the opposite side from the polyester film, or, such a laminate may further comprise a second hardcoated and surface-treated polyester film, wherein the poly(alkyl amine) primed surface of the second polyester film adheres directly to the polymeric interlayer at the opposite side from the first polyester film.

### Surface-Treated Polyester Films

Any polyester films may be used. Preferably, however, the polyester films used here are poly(ethylene terephthalate) (PET) films, or more preferably oriented PET films, or most preferably bi-axially oriented PET films.

The polyester film may have a thickness of about 1 to about 14 mils (about 0.025 to about 0.36 mm), or about 2 to 10 mils (about 0.05 to about 0.25 mm), or about 2 to about 7 mils (about 0.05 to about 0.18 mm).

By “a surface-treated polyester film”, it is meant that the polyester film has the first surface coated with an acrylic based primer and the second surface coated with a poly(alkyl amine) based primer.

The acrylic based primer used here and its application to a polyester film surface is disclosed in U.S. Pat. No. 5,415,942. The acrylic based primers used here are compositions produced from polymers or copolymers of acrylic acid or methacrylic acid or their esters, which may further contain cross-linkable functional groups (such as hydroxy, carboxyl, oxirane, or combinations of two or more thereof) and a condensation product of an amine (e.g., melamine, urea, diazines, their derivatives thereof, or combinations of two or more thereof) and a formaldehyde as a cross-linking agent. The acrylic based primer can be a composition comprising about 40 to about 80 wt % of methyl methacrylate, about 18 to about 60 wt % of ethylacrylate, about 1 to about 15 wt % of methacrylic acid, and about 0.01 to about 25 wt % of hydroxyethylacrylate, and up to about 7.5 wt % of melamine formaldehyde (available under the trade name CYMEL® 301 from American Cyanamid Co, Wayne, N.J.), based on the total weight of the composition.

The poly(alkyl amine) based primers used here include those derived from α-olefin comonomers having 2-10 carbon atoms, such as, ethylene, propylene, 1-butene, 1 pentene, 1-hexene, 1-heptene, 3 methyl-1-butene, 4-methyl-1-pentene, and mixtures thereof. Or, the poly(alkyl amine) used here may be a poly(vinyl amine) (e.g., LUPAMIN® 9095 linear poly(vinyl amine) (BASF Corporation, Florham Park, N.J.)) or a poly(allyl amine). The poly(alkyl amine) may be a poly(allyl amine), or linear poly(allyl amine). The poly(allyl amine) primer or coating, and its application to the polyester film surface(s) are described in U.S. Pat. Nos. 5,411,845; 5,770,312; 5,690,994; 5,698,329; and 7,189,457.

The acrylic based and the poly(alkyl amine) based primers may be applied to the polyester film surface using any suitable process such as spraying, brushing, dipping, or any other means known to one skilled in the art. In general, the primer coating may have a thickness of up to about 10,000 nm, or about 0.2 to about 10,000 nm, or about 10 to about 10,000 nm, or about 10 to about 5,000 nm, or about 10 to about 1,000 nm, or about 10 to about 500 nm.

### Hardcoated and Surface-Treated Polyester Films

By “hardcoated”, it is meant that a clear anti-scratch and anti-abrasion hardcoat is further coated on the first surface of the surface-treated polyester film, as disclosed above, over the acrylic based primer layer. For convenience, from this point forward, the hardcoated side of the polyester film is referred to as the first or the outside surface and the other poly(alkyl amine) primed surface is referred to as the second or the inside surface. Suitable hardcoat may comprise or be produced from polysiloxanes or cross-linked (thermosetting) polyurethanes. Also applicable herein are the oligomeric-based coatings disclosed in U.S. Pat. Appl. No. 2005/0077002, which compositions are prepared by the reaction of (A) hydroxyl-containing oligomer with isocyanate-containing oligomer or (B) anhydride-containing oligomer with epoxide-containing compound. Preferably, however, the hardcoat used here are formed of polysiloxane abrasion resistant coatings (PARC), such as those disclosed in U.S. Pat. Nos. 4,177,315; 4,469,743; 5,415,942; and 5,763,089.

In this invention, the hardcoat generally has a thickness of up to about 100 μm. Specifically, for those hardcoats comprising or produced from polysiloxanes, the thickness of the hardcoat may range from about 1 to about 4.5 μm, or about 1.5 to about 3.0 μm, or about 2.0 to about 2.5 μm, while for those hardcoats comprising or produced from polurethanes, the thickness of the hardcoat may range from about 5 to about 100 μm, or about 5 to about 50 μm.

In addition, a layer of solar control material may be applied to the second or the inside surface of the film underneath the poly(alkyl amine) primer coating. Suitable solar control materials may be infrared absorbing materials, such as metal oxide nanoparticles (e.g., antimony tin oxide nanoparticles, indium tin oxide nanoparticles, or combinations thereof), metal boride nanoparticles (e.g., lanthanum hexaboride nanoparticles), or combinations thereof. The polyester films may also be coated with an infrared energy reflective layer, such a metal layer, a Fabry-Perot type interference filter layer, a layer of liquid crystals, or combinations of two or more thereof.

### Glazing Laminates

The glazing laminates may comprise or be produced from at least one layer of the hardcoated and surface-treated polyester film and a polymeric interlayer, which may bonded or adhered directly to the inside or the poly(alkyl amine) primed surface of the polyester film over the poly(alkyl amine) primer layer.

The polymeric interlayer may comprise or be derived from (or made of) any polymeric material(s) including, but are not limited to, poly(vinyl acetals), poly(vinyl chlorides), polyurethanes, poly(ethylene-co-vinyl acetates), acid copolymers of α-olefins and α,β-unsaturated carboxylic acids having from 3 to 8 carbons, and ionomers derived from partially or fully neutralized acid copolymers of α-olefins and α,β-unsaturated carboxylic acids having from 3 to 8 carbons, or combinations of two or more thereof.

Poly(vinyl acetal) results from the condensation of polyvinyl alcohol with an aldehyde, such as acetaldehyde, formaldehyde, or butyraldehyde. When used as the interlayer material, a suitable amount of plasticizers is comprised in the poly(vinyl acetal) composition. The poly(vinyl acetal) compositions used herein also include acoustic grade compositions. By “acoustic” it is meant that the poly(vinyl acetal) composition has a glass transition temperature (Tg) of 23° C. or less, or about 20° C. to about 23° C.

The ionomers used herein are derived from parent acid copolymers of α-olefins and α,β-ethylenically unsaturated carboxylic acid having 3 to 8 carbons. Preferably, about 15 to about 30 wt %, or about 18 to about 25 wt %, or about 18 to about 23 wt %, of the copolymerized units of the parent acid copolymers are derived from α,β-ethylenically unsaturated carboxylic acids. Preferably, the parent acid copolymers comprise copolymerized units derived from α-olefins having about 2-10 carbon atoms, or α-olefins selected from ethylene, propylene, 1-butene, 1-pentene, 1-hexene, 1-heptene, 3 methyl-1-butene, 4-methyl-1-pentene, and mixtures thereof. More preferably, the α-olefin is ethylene and the α,β-ethylenically unsaturated carboxylic acid is selected from acrylic acid, methacrylic acid, itaconic acid, maleic acid, maleic anhydride, fumaric acid, monomethyl maleic acid, and mixtures thereof.

The parent acid copolymers may be polymerized as disclosed in U.S. Pat. Nos. 3,404,134; 5,028,674; 6,500,888; and 6,518,365.

To produce the ionomers, the parent acid copolymers are neutralized less than 100%, or about 5 to about 90%, or about 10 to about 50%, or about 20 to about 40%, based on the total number of equivalents of carboxylic acid moieties. Upon neutralization with basic metal compounds, the ionomers will contain one or more metallic cations. Metallic ions that are suitable cations may be monovalent, divalent, trivalent, multivalent, or mixtures therefrom. Useful monovalent metallic ions include, but are not limited to, ions of sodium, potassium, lithium, silver, mercury, copper, and mixtures thereof. Useful divalent metallic ions include, but are not limited to, ions of beryllium, magnesium, calcium, strontium, barium, copper, cadmium, mercury, tin, lead, iron, cobalt, nickel, zinc, and mixtures therefrom. Useful trivalent metallic ions include, but are not limited to, ions of aluminum, scandium, iron, yttrium, and mixtures therefrom. Useful multivalent metallic ions include, but are not limited to, ions of titanium, zirconium, hafnium, vanadium, tantalum, tungsten, chromium, cerium, iron, and mixtures therefrom. It is noted that when the metallic ion is multivalent, complexing agents, such as stearate, oleate, salicylate, and phenolate radicals may be included. The parent acid copolymers may be neutralized as disclosed in U.S. Pat. No. 3,404,134.

It is preferred that the polymeric interlayer comprises a poly(vinyl acetal) or an ionomer. More preferably, the polymeric interlayer comprises a poly(vinyl butyral) or an ionomer.

It is understood that the polymeric compositions in the interlayer may further comprise one or more suitable additives. The additives may include fillers, plasticizers, processing aides, flow enhancing additives, lubricants, pigments, dyes, colorants, flame retardants, impact modifiers, nucleating agents, lubricants, antiblocking agents such as silica, slip agents, thermal stabilizers, UV absorbers, UV stabilizers, hindered amine light stablizers, dispersants, surfactants, chelating agents, coupling agents, adhesives, primers and the like.

The polymeric compositions may contain an effective amount of a thermal stabilizer. Thermal stabilizers are well disclosed within the art. Any thermal stabilizer may find utility herein. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and mixtures thereof. This should not be considered limiting. Essentially any thermal stabilizer can be used. The compositions may incorporate up to about 1.0 wt % of thermal stabilizers, based on the total weight of the composition.

The polymeric compositions may contain an effective amount of UV absorber(s). UV absorbers are well disclosed within the art. UV absorbers include benzotriazoles, hydroxybenzophenones, hydroxyphenyl triazines, esters of substituted and unsubstituted benzoic acids, and the like and mixtures thereof. This should not be considered limiting. Essentially any UV absorber may be used. The compositions may contain up to about 1.0 wt % of UV absorbers, based on the total weight of the composition.

The polymeric compositions may contain an effective amount of hindered amine light stabilizers (HALS). Hindered amine light stabilizers are generally well disclosed within the art. Generally, hindered amine light stabilizers are disclosed to be secondary, tertiary, acetylated, N-hydrocarbyloxy substituted, hydroxy substituted N-hydrocarbyloxy substituted, or other substituted cyclic amines which further contain steric hindrance, generally derived from aliphatic substitution on the carbon atoms adjacent to the amine function. This should not be considered limiting. Essentially any hindered amine light stabilizer may be used. The compositions may contain up to about 1.0 wt % of hindered amine light stabilizers, based on the total weight of the composition.

The polymeric interlayer may be in a single-layer or multi-layer form. When in a multi-layer form, the individual sub-layers of the multi-layer polymeric interlayer may independently have any thickness. The polymeric interlayer, as a whole, preferably has a total thickness of at least about 5 mils (0.1 mm), or at least about 30 mils (0.8 mm), or about 30 to about 200 mils (about 0.8 to about 5.1 mm), or about 45 to about 200 mils (about 1.1 to about 5.1 mm), or about 45 to about 100 mils (about 1.1 to about 2.5 mm), or about 45 to about 90 mils (about 1.1 to about 2.3 mm).

The glazing laminate disclosed may further comprise a rigid sheet layer bonded directly to the polymeric interlayer opposite from the hardcoated and surface-treated polyester film.

The rigid sheets used here comprise a material with a modulus of about 100,000 psi (690 MPa) or greater (as measured by ASTM Method D-638). The rigid sheets used here include, but are not limited to, glass sheets, metal sheets, ceramic sheets, and polymeric sheets derived from polycarbonate, acrylic, polyacrylate, poly(methyl methacrylate), cyclic polyolefins (e.g., ethylene norbornene polymers), polystyrene (preferably metallocene-catalyzed), or the like and combinations thereof. Preferably, however, the rigid sheet is made of glass.

The term “glass”, as used herein, refers to window glass, plate glass, silicate glass, sheet glass, low iron glass, and float glass, and also includes colored glass, specialty glass which includes ingredients to control, for example, solar heating, coated glass with, for example, sputtered metals, such as silver or indium tin oxide, for solar control purposes, E-glass, Toroglass, Solex® glass (PPG Industries, Pittsburgh, Pa.) and the like. Such specialty glasses are disclosed in, e.g., U.S. Pat. Nos. 4,615,989; 5,173,212; 5,264,286; 6,150,028; 6,340,646; 6,461,736; and 6,468,934. The glass may also include frosted or etched glass sheets. Suitable frosted and etched glass sheets are articles of commerce and are well known in the art. The type of glass to be selected for a particular laminate depends on the intended use. Preferably, the glass used herein is in the form of sheets.

The glazing laminate may comprise two layers of the hardcoated and surface-treated polyester films (disclosed above) and a polymeric interlayer, wherein the polymeric interlayer is bonded between the two polyester films with direct contact to the poly(alkyl amine) primer layers of the two polyester films.

### Lamination Process

The glazing laminates disclosed here may be produced through any suitable lamination process.

For example, in a conventional autoclave process, the component layers of the glazing laminates are stacked in the desired order to form a pre-lamination assembly. Typically, when one or both of the outer layers of the laminate are polyester films, the pre-lamination assembly may further comprise a rigid cover plate placed over each of the polyester films. The cover plates may be formed of glass or other suitable rigid materials. Optionally, the pre-lamination assembly may still further comprise a release liner placed between the polyester film and the rigid cover plate to facilitate de-airing during the lamination process. The release liners used here may be formed of any suitable polymeric material, such as Teflon® films (DuPont) or polyolefin films. The assembly is then placed into a bag capable of sustaining a vacuum (“a vacuum bag”), the air is drawn out of the bag by a vacuum line or other means, the bag is sealed while the vacuum is maintained (e.g., about 27-28 inches Hg (689-711 mm Hg)), and the sealed bag is placed in an autoclave at a pressure of about 150 to about 250 psi (about 11.3-18.8 bar), a temperature of about 130° C. to about 180° C., or about 120° C. to about 160° C., or about 135° C. to about 160° C., or about 145° C. to about 155° C., for about 10 to about 50 minutes, or about 20 to about 45 minutes, or about 20 to about 40 minutes, or about 25 to about 35 minutes. A vacuum ring may be substituted for the vacuum bag. One type of suitable vacuum bag is disclosed within U.S. Pat. No. 3,311,517.

Alternatively, the pre-lamination assembly may be heated in an oven at about 80° C. to about 120° C., or about 90° C. to about 100° C., for about 20 to about 40 minutes, and thereafter, the heated assembly is passed through a set of nip rolls so that the air in the void spaces between the individual layers may be squeezed out, and the edge of the assembly sealed. The assembly at this stage is referred to as a pre-press.

The pre-press may then be placed in an air autoclave where the temperature is raised to about 120° C. to about 160° C., or about 135° C. to about 160° C., at a pressure of about 100 to about 300 psi (about 6.9 to about 20.7 bar), or about 200 psi (13.8 bar). These conditions are maintained for about 15 to about 60 minutes, or about 20 to about 50 minutes, and after which, the air is cooled while no more air is added to the autoclave. After about 20 to about 40 minutes of cooling, the excess air pressure is vented, the laminated products are removed from the autoclave and the cover plates and the release liners are removed from the final glazing laminates.

The glazing laminates may also be produced through non-autoclave processes. Such non-autoclave processes are disclosed, for example, within U.S. Pat. Nos. 3,234,062; 3,852,136; 4,341,576; 4,385,951; 4,398,979; 5,536,347; 5,853,516; 6,342,116; and 5,415,909, U.S. Pat. Appl No. 2004/0182493, European Pat. No. EP 1 235 683 B1, and PCT Pat. Appl. Nos. WO 91/01880 and WO 03/057478 A1. Generally, the non-autoclave processes include heating the pre-lamination assembly and the application of vacuum, pressure or both. For example, the assembly may be successively passed through heating ovens and nip rolls.

This should not be considered limiting. Essentially any lamination process may be used.

### EXAMPLES

The following Examples and Comparative Examples are intended to be illustrative of the present invention, and are not intended in any way to limit the scope of the present invention.

### Surfaced-Treated Polyester Films:

The following surface-treated poly(ethylene terephthalate) films were prepared:
PET1: This was a PET cast film primed in-line on the air side with a 2-hydroxyethylacrylate hydrosol bath (as taught in U.S. Pat. No. 5,415,942) and on the wheel side with a cross-linked poly(allyl amine) coating (as taught in U.S. Pat. No. 7,189,457) prior to any stretching operations.
PET2: This was a PET cast film primed in-line on both the air side and the wheel side with a cross-linked poly(allyl amine) coating (as taught in U.S. Pat. No. 7,189,457) prior to any stretching operations.
PET3: This was a flame-treated CRONAR™ PET film available from DuPont.

### Glass/Plastic Laminates:

Six (6) glass/plastic laminates (CE1-4 and E1-2) with the structure of “Glass/PVB/PET/PARC” were prepared as follows. First, the PET films were hardcoated by either (a) manually applying a polysiloxane abrasion resistant coating (PARC) (as disclosed in U.S. Pat. No. 5,415,942) to one side of the PET film using a No. 16 Meyer rod, followed by drying at room temperature (CE2-4 and E1) or (b) applying the PARC to one side of the PET film on a commercial scale line using a slot die coating head (CE1 and E2). Then, the hardcoated PET film was laid over a BUTACITE™ poly(vinyl butyral) interlayer sheet (DuPont), which was in turn laid over a sheet of class. The final laminate was obtained by vacuum bagging such a pre-lamination assembly, followed by heating the assembly in an autoclave for 30 minutes at a temperature of 135° C. and a pressure of about 200 psi (13.8 bar).

The PET films used in each of the six (6) laminates (CE1-4 and Examples E1-2) were as follows
CE1: PET3;
CE2: PET2 with the wheel side adjacent to PARC;
CE3: PET2 with the air side adjacent to PARC;
CE4: PET1 with the wheel side (poly(allyl amine) primed) adjacent to PARC;
E1: PET1 with the air side (2-hydroxyethylacrylate hydrosol primed) adjacent to PARC; and
E2: PET1 with the air side (2-hydroxyethylacrylate hydrosol primed) adjacent to PARC.

The laminated samples were then measured for (a) optical properties (according with ASTM D1003-61 (re-approved 1977); (b) adhesion strength between the PET films and PARC prior to and after immersing the laminates in boiling water for 6 hours (according to ASTM method D3359-97); and (c) 90° angle peel strength between the PVB interlayer sheets and the PET films after immersing the laminates in boiling water for 6 hours. The 90° angle peel strength was measured using a peel strength tester supplied by INSTRON Industrial Products and Instrumentors, Inc., Grove, Pa. Specifically, the laminated samples were first cut into sizes of about 2 in (5.1 cm) by about 8-12 in (20-31 cm). The PET film on the surface of each of the laminates was precisely cut through along the long axis of the laminate with the two cuts being about ¼ in (0.6 cm) to about 1 in (2.5 cm) apart. The PET film strip between the two cuts was peeled up at one end so that it could be attached to the load cell clamp of the peel tester. The laminate was mounted in a 90° angle peel testing jig by securing it along the edges of both long sides. The jig was then mounted so that it moved as the PET film was peeled to maintain a 90° angle of peel. The peels were conducted at speeds of about 1 or 2 in/min (2.5 or 5.1 cm/min). Once the peel force settled on a relatively constant level, the average peel strength being measured by the appropriate load cell over about 0.1 in (0.25 cm) to about 2 in (5.1 cm) of peel distance was averaged to give the peel strength in pounds force per inch of PET film width. In addition, hardcoat blistering was examined using a DIC microscope after immersing the laminates in boiling water for 6 hours. The results are tabulated in Table 1.

As shown by E1 and E2, the 2-hydroxyethylacrylate hydrosol primer provided sufficient adhesion between the PET films and PARC even after 6 hours immersion in boiling water. The poly(alkyl amine) primer, however, fails to provide sufficient adhesion between the PET films and PARC after 6 hours immersion in boiling water (as shown in CE2-4). Additionally, hardcoat blistering would appear after 6-hour boiling water immersion when poly(allyl amine) was used to bond the PET films and PARC(CE2-4), but not when 2-hydroxyethylacrylate hydrosol was used to bond the PET films with PARC (E1 and E2). On the other hand, both the flame-treatment and 2-hydroxyethylacrylate hydrosol fail to provide sufficient adhesion strength between the PET films and the PVB Interlayer sheets (CE1 and CE4), when compared to poly(allyl amine) (CE2, CE3, E1, and E2).

TABLE 1

| | | | | | PET/PARC | | | |
|---|---|---|---|---|---|---|---|---|
| | Raw Film | Lamination Opticals | | b* | Adhesion (%) | | Speckling (6 hr. boil) | PET/PVB Adhesion |
| Sample | Haze (%) | Haze (%) | Tvis (%) | color | As-Claved | 6 hr. Boil | (No./cm²/Dia. (mm)) | (lb/inch) |
| CE1 | ~0.35 | 0.77 | 91.8 | 1.99 | 100 | 100 | 0/0 | 9.3 |
| CE2 | 0.35 | 0.71 | 92.5 | 1.31 | 100 | 20 | 1,893/0.160 | 18.4 |
| CE3 | 0.25 | 1.11 | 92.4 | 1.28 | 100 | 16 | 1,516/0.198 | 15.2 |
| CE4 | 0.59 | 1.05 | 92.4 | 1.41 | 100 | 44 | 781/0.278 | 3.4 |
| E1 | 0.59 | 0.89 | 92.5 | 1.23 | 100 | 100 | 0/0 | 16.2 |
| E2 | 0.95 | 0.43 | 92.7 | — | 100 | 100 | 0/0 | 23.6 |

1. A surface-treated polyester film comprising a first surface primed with an acrylic based primer and a second surface primed with a poly(alkyl amine) based primer wherein each of the primer layers optionally has a thickness of up to about 10,000 nm.

2. The film of claim 1, wherein the polyester film is a poly(ethylene terephthalate) film.

3. The film of claim 2, wherein the polyester film is a bi-axially oriented poly(ethylene terephthalate) film having a thickness of about 1 to about 14 mils (about 0.025 to about 0.36 mm).

4. The film of claim 1, wherein the acrylic based primer comprises about 40 to about 80 wt% of methyl methacrylate, about 18 to about 60 wt% of ethylacrylate, about 1 to about 15 wt% of methacrylic acid, and about 0.01 to about 25 wt% of a copolymerized monomer having a cross-linkable functional group selected from hydroxyl, carboxy, and oxirane, and up to about 7.5 wt% of condensation product of an amine and a formaldehyde, based on the total weight of the primer composition.

5. The film of claim 4, wherein the amine comprised in the poly(alkyl amine) based primer is selected from the group consisting of melamine, urea, diazines, melamine derivative, urea derivative, diazine derivative, or combinations of two or more thereof.

6. The film of claim 4, wherein the polyester film is a poly(ethylene terephthalate) film or a bi-axially oriented poly(ethylene terephthalate) film having a thickness of about 1 to about 14 mils (about 0.025 to about 0.36 mm).

7. The film of claim 1 wherein the poly(alkyl amine) based primer comprises a poly(allyl amine).

8. The film of claim 6 wherein the poly(alkyl amine) based primer comprises a poly(allyl amine).

9. The film of claim 1 further comprising an abrasion resistant hardcoat coated on the first surface over the acrylic based primer.

10. The film of claim 9 wherein the abrasion resistant hardcoat comprises or is produced from one or more polysiloxanes, cross-linked polyurethanes, or compositions prepared by reacting (a) hydroxyl-containing oligomers with isocyanate-containing oligomers or (b) anhydride-containing oligomers with epoxide-containing compounds.

11. The film of claim 10, wherein the abrasion resistant hardcoat comprises or is produced from one or more polysiloxanes.

12. An article having laminated thereon or therewith the film as recited in claim 9.

13. The article of claim 12 wherein the poly(alkyl amine) primed surface of the film adheres to a polymeric interlayer sheet and the interlayer sheet optionally has a thickness of about 30 to about 200 mils (about 0.8 to about 5.1 mm).

14. The article of claim 13, wherein the interlayer sheet comprises or is produced from poly(vinyl acetal), poly(vinyl chloride), polyurethane, poly(ethylene-co-vinyl acetates), acid copolymer, ionomer of the acid copolymer, combination of two or more thereof and the acid copolymer comprises repeat units derived from an ct-olefin and one or more α, β-unsaturated carboxylic acids having from 3 to 8 carbons.

15. The article of claim 14 further comprising a rigid sheet having a modulus of at least about 100,000 psi (690 Mpa) and adhering directly to the polymeric interlayer opposite from the hardcoated surface-treated polyester film.

16. The laminated article of claim 15 wherein rigid sheet is a glass, metal, ceramic, polymeric sheet, or combinations of two or more thereof.

17. The laminated article of claim 16, wherein the rigid sheet is a glass sheet.

18. The laminated article of claim 13 comprises two layers of the films as recited in claim 9 and the polymeric interlayer is bonded between the two films with direct contact to the poly(alkyl amine) primer layers of the two films.

19. An article having laminated thereon or therewith a film as recited in claim 10 and the article comprises a polymeric interlayer sheet adhering to the poly(alkyl amine) primed surface of the film and having a thickness of about 30 to about 200 mils (about 0.8 to about 5.1 mm).
